(19) United States
(12) Patent Application Publication
(10) Pub. No.: US 2008/0253333 A1
(43) Pub. Date: Oct. 16, 2008

(54) Call Admission Control Method for Use in Packet Based Communication System

(75) Inventors: Tae-Chul Hong, Daejon (KR); Kun-Seok Kang, Daejon (KR); Do-Seob Ahn, Daejon (KR); Ho-Jin Lee, Daejon (KR)

Correspondence Address: RABIN & Berdo, PC, 1101 14TH STREET, NW, SUITE 500, WASHINGTON, DC, 20005, US

(73) Assignee: ELECTRONICS & TELECOMMUNICATIONS RESEARCH INSTITUTE, Daejeon (KR)

(21) Appl. No.: 12/066,723

(22) PCT Filed: Jul. 24, 2006
(86) PCT No.: PCT/KR06/02905

§ 371 Date: Mar. 13, 2008

(30) Foreign Application Priority Data
Sep. 14, 2005 (KR) 10-2005-0085904

(51) Int. Cl. H04Q 7/00

(52) U.S. Cl. 370/331

(57) ABSTRACT

Provided is a call admission control method for use in a packet based communication system, which can secure a handoff and a quality of service (QoS) by discriminating a new call and a handoff call and borrowing a shared bandwidth, a reserved bandwidth, and a bandwidth of other service according to kinds of services and their characteristics. The call admission control method includes the steps of: a) dividing frequency band into a reservation band and a shared band for communication service handoff call and multicast service handoff call, and determining whether a call admission request of users is a new call or a handoff call; b) when the call admission request is the new call, determining whether to accept the call admission request by allocating the shared band and a band borrowed from other service; and c) when the call admission request is the handoff call, determining whether to accept the call admission request by allocating the shared band, the reserved band, and the borrowed band according to services and bandwidth resources.

### TECHNICAL FIELD

The present invention relates to a call admission control method for providing a broadcasting and multicast service and a communication service in a packet based communication system; and, more particularly, to a call admission control method for use in a packet based communication system, which can secure a handoff and a quality of service (QoS) by discriminating a new call and a handoff call and borrowing a shared bandwidth, a reserved bandwidth, and a bandwidth of other service according to kinds of services and their characteristics.

### BACKGROUND ART

Radio resource management technologies play an important role in providing service of quality (QoS) in radio communication system. Network plan, radio interface design, and radio resource management policy determine the QoS of network level as well as user's individual level.

The radio resource management technologies are to allocate resources, such as frequencies, time channels, and transmission power, to the users, such that a total network yield, a total resource utilization, or a total network profit can be maximized.

Restrictions in allocation of resources are a call blocking/dropping rate and a minimum signal to interference ratio.

The performance of the radio resource management technology directly affects the overall performance of the network as well as the performance of the individual users. For example, power allocated to one user determines the QoS of the user and also influences the interference level of the network.

The radio resource management technologies can be classified into three groups.

The first group relates to a frequency/time resource allocating method such as a channel allocation, a scheduling, a transmission speed control, and a bandwidth reservation.

The second group relates to a power allocation and control method for controlling transmission power between a mobile station and a base station.

The third group relates to a call admission control, a base station allocation, and a handoff algorithm.

The call admission control has been also studied as a basic tool in a cable network for a congestion control and QOS. However, the call admission control in the wireless network is much more complicated due to channel multi-access interference, channel damage, handoff request, and limited bandwidth.

The call admission control in the wireless network has been paid attention to because the number of users who use the wireless communication increases and the call admission service plays an important role in providing the QoS.

In the 1^{st} and 2^{nd} generation wireless communication systems, the cal admission control has been developed for one service. In the 3^{rd} generation wireless communication system, multimedia services such as voice, video, data and audio are provided according to various QoS demands. Accordingly, much more complicated call admission control methods have to be developed so as to cope with these changes.

The existing call admission control has been studied for controlling signal quality and handoff failure probability. However, in recent years, various services have to be considered. Therefore, various types of call admission control technologies, such as packet-level QoS parameter control, transmission speed control, network profit basis, service and class priority, and fairness, have been developed.

Meanwhile, the call admission control methods are disclosed in Korean Patent Application No. 10-2003-0081053 entitled Call admission control apparatus and method for providing quality of service in portable Internet network, Koran Patent Application No. 10-2000-0061082 entitled Call admission control method of real time and non real time services in wideband code division multiple access cellular system, and U.S. Pat. No. 5,884,174 entitled “Call Admission Control for Wireless Networks”. These call admission control methods can secure handoff call and can use radio resources more efficiently, but cannot meet the user's satisfaction because they do not consider QoS according to services.

### DISCLOSURE OF INVENTION

### Technical Problem

It is, therefore, an object of the present invention to provide a call admission control method for use in a packet based communication system, which can secure a handoff and a quality of service (QoS) by discriminating a new call and a handoff call and borrowing a shared bandwidth, a reserved bandwidth, and a bandwidth of other service according to kinds of services and their characteristics.

### Technical Solution

In accordance with one aspect of the present invention, there is provided a call admission control method for use in a packet based communication system, including the steps of: a) dividing frequency band into a reservation band and a shared band for communication service handoff call and multicast service handoff call, and determining whether a call admission request of users is a new call or a handoff call; b) when the call admission request is the new call, determining whether to accept the call admission request by allocating the shared band and a band borrowed from other service; and c) when the call admission request is the handoff call, determining whether to accept the call admission request by allocating the shared band, the reserved band, and the borrowed band according to services and bandwidth resources.

### ADVANTAGEOUS EFFECTS

The present invention can reduce the handoff failure probability of the packet based communication system that provides the broadcasting, multicast and communication services using the satellite. In addition, the present invention can increase the frequency utilization efficiency and improve the user satisfaction, considering the QOS based on the services.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram illustrating a frequency utilization method for providing a communication service and a broadcasting and multicast service;

FIG. 2 is a diagram illustrating a method for providing a communication service and a broadcasting and multicast service through satellite;

FIG. 3 is a flowchart illustrating a call admission control method in accordance with an embodiment of the present invention;

FIG. 4 is a flowchart illustrating a process of borrowing a handoff bandwidth in the call admission control method in accordance with the embodiment of the present invention;

FIG. 5 is a flowchart illustrating a process of borrowing bandwidth for a new communication service in the call admission control method in accordance with the embodiment of the present invention;

FIG. 6 is a flowchart illustrating a process of borrowing bandwidth for a new streaming service in the call admission control method in accordance with the embodiment of the present invention; and

FIG. 7 is a flowchart illustrating a process of increasing bandwidth in the call admission control method in accordance with the embodiment of the present invention.

### BEST MODE FOR CARRYING OUT THE INVENTION

Other objects and aspects of the invention will become apparent from the following description of the embodiments with reference to the accompanying drawings, which is set forth hereinafter.

Although the embodiments of the present invention will be described in a satellite system environment, a call admission control method of the present invention can also be equally applied to a terrestrial mobile communication system where cells are formed around a base station.

FIG. 1 is a diagram illustrating a frequency utilization method for providing a communication service and a broadcasting and multicast service.

A first frequency utilization method is to divide a frequency band into a communication service band 110 and a broadcasting and multicast service band 120. In this case, all admission control or scheduler can be simply designed. However, frequency utilization efficiency is degraded.

A second frequency utilization method is to divide a frequency band into a communication handoff call reservation band 130, a shared band 140, and a multicast handoff call reservation band 150 so that a communication service and a broadcasting and multicast service share the same frequency band. In this case, both the communication service and the broadcasting and multicast service can use the shared band 140 according to an amount of traffic, thus increasing the frequency utilization efficiency. However, in order to increase the frequency efficiency while satisfying QoS of both the communication service and the broadcasting and multicast service, the design of the call admission control or scheduler becomes complicated.

In accordance with the present invention, the broadcasting and multicast service is a content-based service. Thus, the broadcasting is not continuously transmitted using the fixed bandwidth, just as the exiting broadcasting, but it is transmitted when a plurality of content providers have contents to be transmitted. Therefore, it is preferable to adaptively use the shared band according to the situations as shown in the second method rather than to use the fixed frequency band as shown in the first method. Also, a major object of the communication service is to provide communications to the users without interruption in zones that a terrestrial network cannot manage. Therefore, the second method that can adaptively allocate the bandwidth according to the situations is more preferable to the allocation of the fixed bandwidth.

For these reasons, the present invention designs the call admission control method, assuming that the frequency bandwidth is shared as shown in the second method.

Unlike the existing circuit switching scheme, the packet based scheme can adjust transmission speed with respect to users through a packet scheduler. Therefore, using the packet scheduler, the shared band can be adaptively allocated according to the situations. After the transmission starts, the transmission speed can be adjusted through the packet scheduler and thus a more flexible call admission control can be supported.

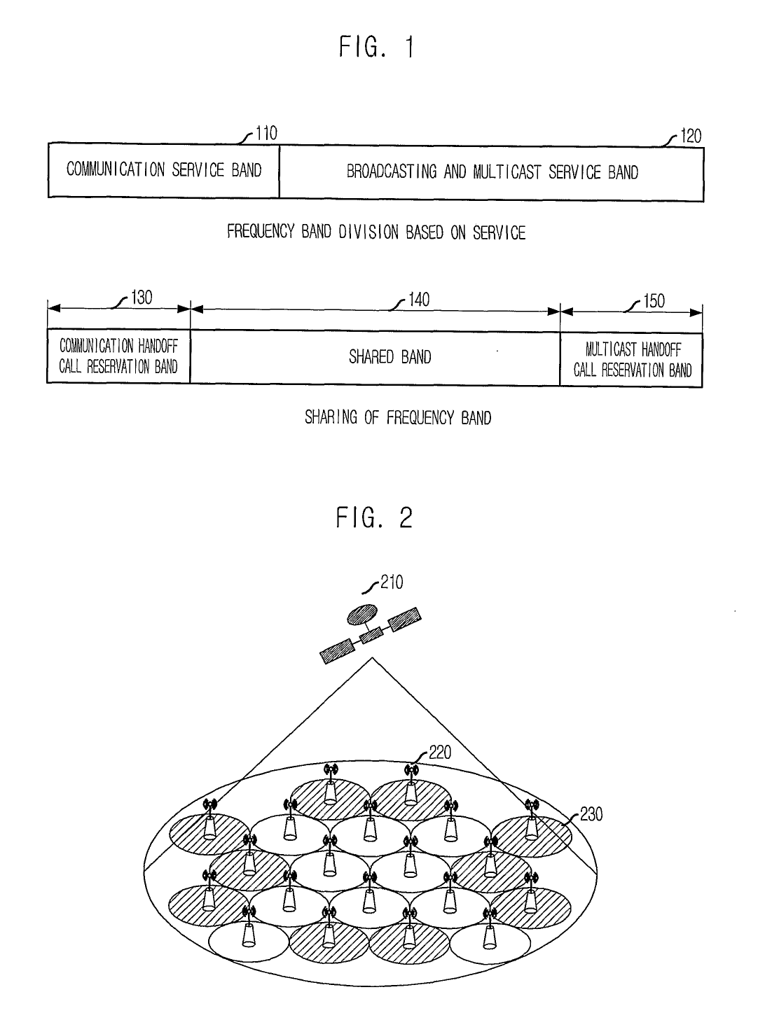

FIG. 2 is a diagram illustrating a method for providing a communication service and a broadcasting and multicast service through satellite.

A major object of the communication service is to provide service without interruption in a zone that a terrestrial network cannot manage. Therefore, a satellite 210 mainly manages the communications in an outer zone 230 of a cell that a base station 220 manages.

An object of the broadcasting and multicast service is to provide service in all zones, regardless of zones of a terrestrial network.

In FIG. 2, outer cells expressed by dark color are the outermost cells 230. The base station of the terrestrial network may not provide communications in the outside of these outer cells 230. Because there is high probability that the users will use satellite communication service in these cells, the outermost cells report the number Nc of the users using the communication service to the satellite system. The satellite system sums the values Nc reported from the terrestrial base stations and adjusts the handoff call reservation band as much as a predetermined ratio α.

An initial handoff call reservation band is determined by the user and the reservation bandwidth is adjusted using the information of the outermost cells 230. The adjustment of the reservation bandwidth is determined according to the situations of the shared band.

If satisfying Eq. 1 below, bandwidth as much as Eq. 2 below is additionally reserved. If not, a current reservation bandwidth is maintained.

(B_{SC}−B_{OC})+B_{CHRR}−(ΣN_{C}α)≧β Eq. 1

where B_{SC}, B_{OC}, B_{CHRR}, and N_{C} represent the bandwidth of the shared channel, the bandwidth that is being currently used in the shared channel, the bandwidth that is not currently used in the bandwidth reserved for the communication service handoff, and the number of users, respectively.

(ΣN_{C}×α)−B_{CHRR} Eq. 2

Just as the initial handoff call reservation band, the handoff call reservation bands α and β are determined by the service provider.

The multicast service can be provided in cooperation with the terrestrial network or can be provided from the satellite system alone. In the former case, a special handoff support is not required when the multicast service that the user has received in the outermost cell is also provided through the satellite. However, if the multicast service that the user has received from the outermost cell is not provided through the satellite, a process such as the communication service is required.

In the case of the multicast service, the bandwidth is not reserved through the number of users, just as the communication service, but the multicast content list being provided from the outermost cell is reported and the bandwidth of the contents that the satellite system has not provided is reserved.

In the case where the multicast service is provided from the satellite system alone, handoff between multibeams of the satellite may occur. In this case, when handoff occurs toward other beams, a handoff support is not required if the multicast service that the user has received from previous beam is equally provided. However, if the multicast service that the user has received is handed off to other beam and is not provided from the moved beam area, the process such as the communication service is required.

The broadcasting service is basically transmitted to all users and thus is equally provided to all cells. Therefore, the handoff support is not required.

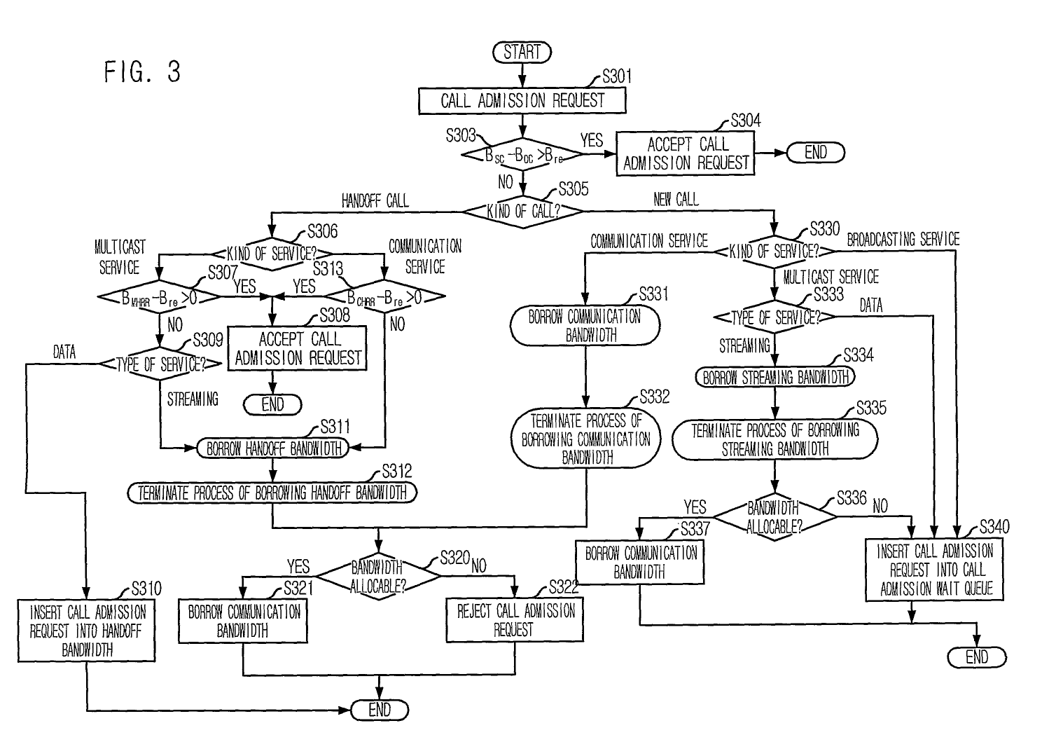

FIG. 3 is a flowchart illustrating a call admission control method in accordance with an embodiment of the present invention.

Referring to FIG. 3, in steps S301 and S303, when a call admission request occurs in a central station such as a satellite or a terrestrial base station, it is determined whether (B_{SC}−B_{OC}) is greater than Bᵣₑ where Bᵣₑ denotes the bandwidth requested in the call admission request. In step S304, if (B_{SC}−B_{OC}) is greater than Bᵣₑ, the call admission request is accepted because the shared channel can be allocated, and the process is terminated. In step S305, if (B_{SC}−B_{OC}) is not greater than Bᵣₑ, it is determined whether the kind of the call is a handoff call or a new call.

In step S306, when the requested call is the handoff call, it is determined whether the type of the service is a multicast service or a communication service.

In step S307, if the type of the service is the multicast service, it is determined whether (B_{MHRR}−Bᵣₑ) is greater than zero where B_{MHRR} denotes the bandwidth that is not currently used in the bandwidths reserved for the multicast handoff. In step S308, if (B_{MHRR}−Bᵣₑ) is greater than zero, the call admission request is accepted because the reserved bandwidth can be allocated, and the process is terminated. In step S309, if (B_{MHRR}−Bᵣₑ) is not greater than zero, it is determined whether the type of the multicast service is data or streaming. In step S310, if the type of the multicast service is the data, the requested handoff call is inserted into a handoff call admission wait queue and the process is then terminated. In steps S311 and S312, if the type of the multicast service is the streaming, a process of borrowing handoff bandwidth is performed and the process is terminated. In step 310, the call admission request inserted into the handoff call admission wait queue accepts the call when margin occurs in the shared band. That is, the shared bandwidth is allocated with higher priority than that of a general call admission wait queue or a new call admission request.

Meanwhile, if the kind of the multicast service is the streaming in step S309, the process of borrowing the handoff bandwidth is performed in step S311 and the process is terminated in step S312. In step S320, it is determined whether the bandwidth requested through the process of borrowing the bandwidth by the user can be allocated. In step S321, if the requested bandwidth can be allocated, the call admission request is accepted and the process is terminated. In step 322, if the requested bandwidth cannot be allocated, the call admission request is rejected and the process is terminated.

If the service of the handoff call is the communication service in step S306, it is determined whether (B_{CHRR}−Bᵣₑ) is greater than zero. If (B_{CHRR}−Bᵣₑ) is greater than zero, the call admission request is accepted in step S308 because the reserved bandwidth can be allocated. If (B_{CHRR}−Bᵣₑ) is not greater than zero, the process proceeds to step S311.

In step S330, if the kind of the call is the new call in step S305, it is determined whether the kind of the service is a communication service, a multicast service, or a broadcasting service.

In steps S331 and S332, if the kind of the service is the communication service in step S330, a process of borrowing bandwidth for the new communication service is performed, and the process is terminated. Then, the process proceeds to step S320.

In step S333, if the kind of the service is the multicast service in step S330, it is determined whether the type of the service is data or streaming. In steps S334 and S335, if the type of the service is the streaming, a process of borrowing bandwidth for the new streaming service is performed, and the process is terminated. In step S336, it is determined whether the bandwidth requested through the process of borrowing the bandwidth by the user can be allocated. In step S337, if the requested bandwidth can be allocated, the call admission request is accepted and the process is terminated. In step 340, if the requested bandwidth cannot be allocated, the call admission request is inserted into the call admission wait queue and the process is terminated. At this point, the call admission request inserted into the handoff call admission wait queue accepts the call when margin occurs in the shared band.

If the type of the service is the data in step S333, the process proceeds to step S340 of inserting the call admission request into the call admission wait queue.

If the type of the service is the broadcasting service in step S330, the process proceeds to step S340.

That is, the call admission control method in accordance with the present invention reserves in advance the bandwidth for the handoff and borrows the bandwidth from the data service, which is being currently provided, when the bandwidths for the handoff call are all used, thus increasing the probability that can provide the service without interruption. Also, when reserving the bandwidth for the handoff, the probability that the handoff call will occur is estimated through the information from the neighboring base stations, so that the reservation bandwidth can be adjusted. If the newly requested call is the broadcasting and multicast data service, the call admission request is inserted into the call admission wait queue. In the case of the other services, the bandwidth is borrowed from the data service, thus increasing the call admission rate.

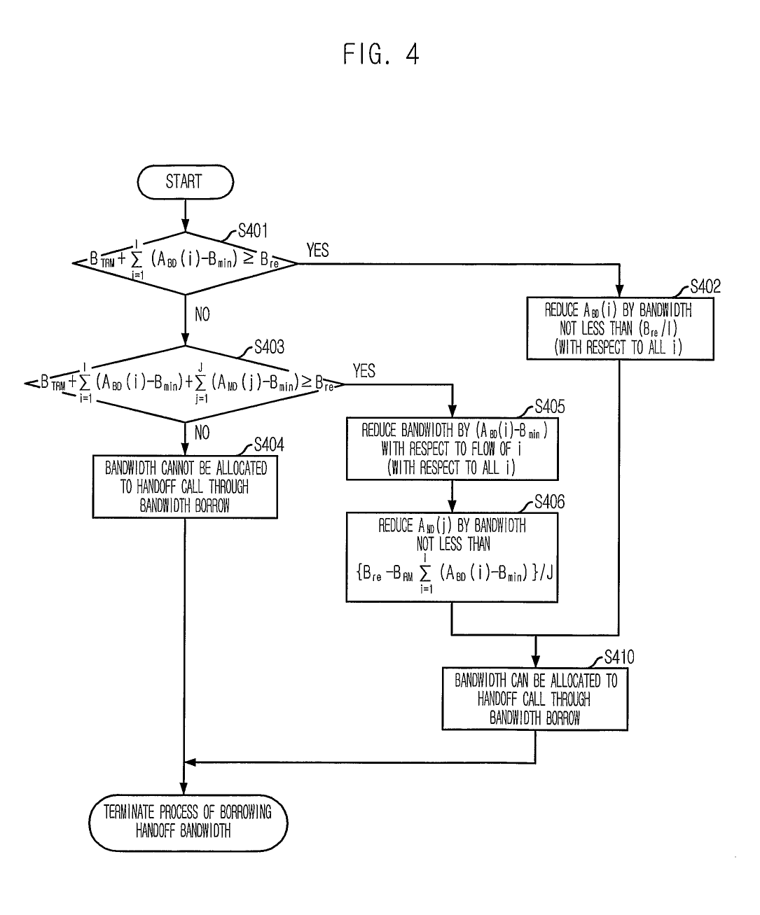

FIG. 4 is a flowchart illustrating a process of borrowing a handoff bandwidth in the call admission control method in accordance with the embodiment of the present invention.

In the process of borrowing the handoff bandwidth of the call admission control method, it is determined whether Eq. 3 below is satisfied in step S401.

$${B}_{TRM} + {\sum }_{i = 1}^{I} ( {A}_{BD} ( i ) - {B}_{min} ) \geq {B}_{re} \qquad Eq . 3$$

where B_{TRM} is B_{MHRR}+(B_{SC}−B_{OC}) for the multicast service and B_{CHRR}+(B_{SC}−B_{OC}) for the communication service. A (i) represents the bandwidth that is used by an i^{th} broadcasting data service, I represents a total number of broadcasting data services, Bₘᵢₙ represents the minimum requested bandwidth for providing the data service, and Bᵣₑ represents the bandwidth requested by the user.

In step S402, if Eq. 3 is satisfied in step S401, A_{BD}(i) is reduced with respect to all i by bandwidth that is not less than (Bᵣₑ/I). In step S410, it is checked that the bandwidth can be allocated to the handoff call through the process of borrowing the bandwidth and the process is terminated.

In step S403, if Eq. 3 is not satisfied, it is determined whether Eq. 4 below is satisfied.

$${B}_{TRM} + {\sum }_{i = 1}^{I} ( {A}_{BD} ( i ) - {B}_{min} ) + {\sum }_{j = 1}^{J} ( {A}_{MD} ( j ) - {B}_{min} ) \geq {B}_{re} , \qquad Eq . 4$$

where A_{MD(j)} is the bandwidth that is used by a j^{th} multicast data service, and J represents the number of multicast data services.

In step S405, if Eq. 4 is satisfied, A_{MD}(j) is reduced with respect to all j by bandwidth that is not less than

$$\{ {B}_{re} - {B}_{TRM} - {\sum }_{i = 1}^{I} ( {A}_{BD} ( i ) - {B}_{min} ) \} / J . ,$$

Then, the process proceeds to step S410. That is, it is checked that the bandwidth can be allocated to the handoff call through the process of borrowing the bandwidth, and the process is terminated.

If Eq. 4 is not satisfied in step S403, it is checked in step S404 that the bandwidth cannot be allocated to the handoff call through the process of borrowing the bandwidth, and the process is terminated.

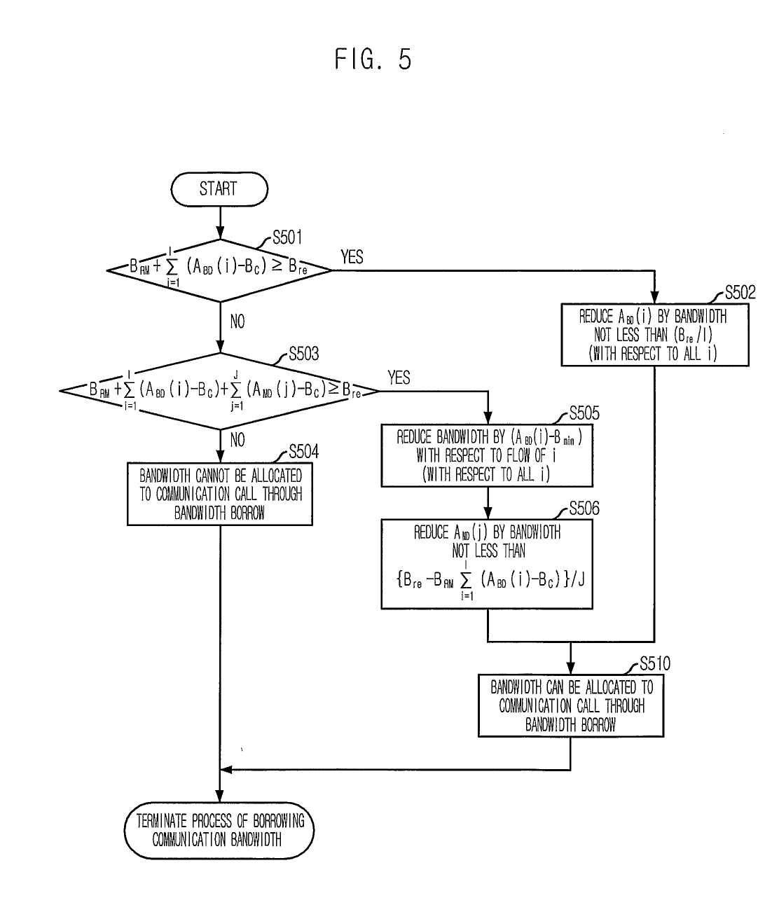

FIG. 5 is a flowchart illustrating a process of borrowing bandwidth for a new communication service in the call admission control method in accordance with the embodiment of the present invention.

Referring to FIG. 5, in the process of borrowing the bandwidth for the new communication service, it is determined whether Eq. 5 below is satisfied in step S501.

$${B}_{RM} + {\sum }_{i = 1}^{I} ( {A}_{BD} ( i ) - {B}_{C} ) \geq {B}_{re} , \qquad Eq . 5$$

where B_{RM} is (B_{SC}−B_{OC}), A_{BD}(i) represents the bandwidth that is used by an i^{th} broadcasting data service, and B_{c} represents the bandwidth that has to be allocated to the data service while not being borrowed for the new communication service.

In step S502, if Eq. 5 is satisfied in step S501, A_{BD}(i) is reduced with respect to all i by bandwidth that is not less than (Bᵣₑ/I). In step S510, it is checked that the bandwidth can be allocated to the new communication service call through the process of borrowing the bandwidth and the process is terminated.

In step S503, if Eq. 5 is not satisfied, it is determined whether Eq. 6 below is satisfied.

$${B}_{RM} + {\sum }_{i = 1}^{I} ( {A}_{BD} ( i ) - {B}_{C} ) + {\sum }_{j = 1}^{J} ( {A}_{MD} ( j ) - {B}_{C} ) \geq {B}_{re} \qquad Eq . 6$$

where A_{MD(j)} is the bandwidth that is used by a j^{th} multicast data service, and J represents the number of multicast data services.

In step S505, if Eq. 6 is satisfied, the bandwidth is reduced with respect to flow of all i by (A_{BD}(i)−BC). In step S506, A_{MD}(j) is reduced with respect to all j by bandwidth that is not less than

$$\{ {B}_{re} - {B}_{RM} - {\sum }_{i = 1}^{I} ( {A}_{BD} ( i ) - {B}_{C} ) \} / J .$$

Then, the process proceeds to step S510. That is, it is checked that the bandwidth can be allocated to the new communication service call through the process of borrowing the bandwidth.

If Eq. 6 is not satisfied in step S503, it is checked in step S504 that the bandwidth cannot be allocated to the new communication service call through the process of borrowing the bandwidth, and the process is terminated.

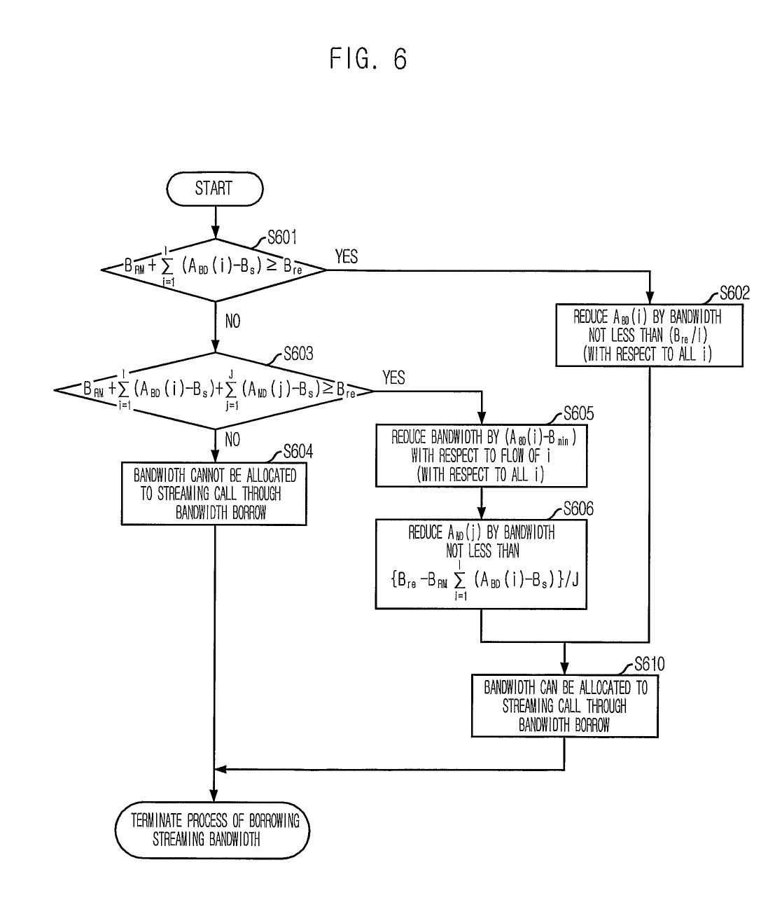

FIG. 6 is a flowchart illustrating a process of borrowing bandwidth for a new streaming service in the call admission control method in accordance with the embodiment of the present invention.

Referring to FIG. 6, in the process of borrowing the bandwidth for the new streaming service, it is determined whether Eq. 7 below is satisfied in step S601.

$${B}_{RM} + {\sum }_{i = 1}^{I} ( {A}_{BD} ( i ) - {B}_{S} ) \geq {B}_{re} \qquad Eq . 7$$

where B_{RM} is (B_{SC}−B_{OC}), A_{BD}(i) represents the bandwidth that is used by an i^{th} broadcasting data service, and B_{C} represents the bandwidth that has to be allocated to the data service while not being borrowed for the new streaming service.

In step S602, if Eq. 7 is satisfied in step S601, A (i) is reduced with respect to all i by bandwidth that is not less than (Bᵣₑ/I). In step S610, it is checked that the bandwidth can be allocated to the new streaming service call through the process of borrowing the bandwidth and the process is terminated.

In step S603, if Eq. 7 is not satisfied, it is determined whether Eq. 8 below is satisfied.

$${B}_{RM} + {\sum }_{i = 1}^{I} ( {A}_{BD} ( i ) - {B}_{S} ) + {\sum }_{j = 1}^{J} ( {A}_{MD} ( j ) - {B}_{S} ) \geq {B}_{re} \qquad Eq . 8$$

where A_{MD(j)} is the bandwidth that is used by a j^{th} multicast data service, and J represents the number of multicast data services.

In step S605, if Eq. 6 is satisfied, the bandwidth is reduced with respect to flow of all i by (A_{BD}(i)−BC). In step S606, A_{MD}(j) is reduced with respect to all j by bandwidth that is not less than

$$\{ {B}_{re} - {B}_{RM} - {\sum }_{i = 1}^{I} ( {A}_{BD} ( i ) - {B}_{S} ) \} / J .$$

Then, the process proceeds to step S610. That is, it is checked that the bandwidth can be allocated to the new streaming service call through the process of borrowing the bandwidth.

If Eq. 8 is not satisfied in step S603, it is checked in step S604 that the bandwidth cannot be allocated to the new streaming service call through the process of borrowing the bandwidth, and the process is terminated.

The process of borrowing the handoff bandwidth is performed using all bandwidths other than the minimum bandwidth of the data service provided for reducing the occurrence rate of the handoff. However, in the case of the new communication service or the streaming service, the degradation of user satisfaction is not great compared with the handoff. Therefore, the process of borrowing the bandwidth is performed in the environment that secures the data service as much as an arbitrary level determined by the service operator, not the minimum bandwidth.

The bandwidth borrowed through the process of borrowing the bandwidth determines whether to return to the existing data services according to the margin of the shared band. The reason for this is that the shared bandwidth is insufficient in the case of the bandwidth borrowing process that has been performed. Therefore, in the case where the call that borrowed the bandwidth is terminated or other existing calls are terminated and thus the shared bandwidth is expanded, it is determined whether to increase the bandwidth for the data services that lends the bandwidths.

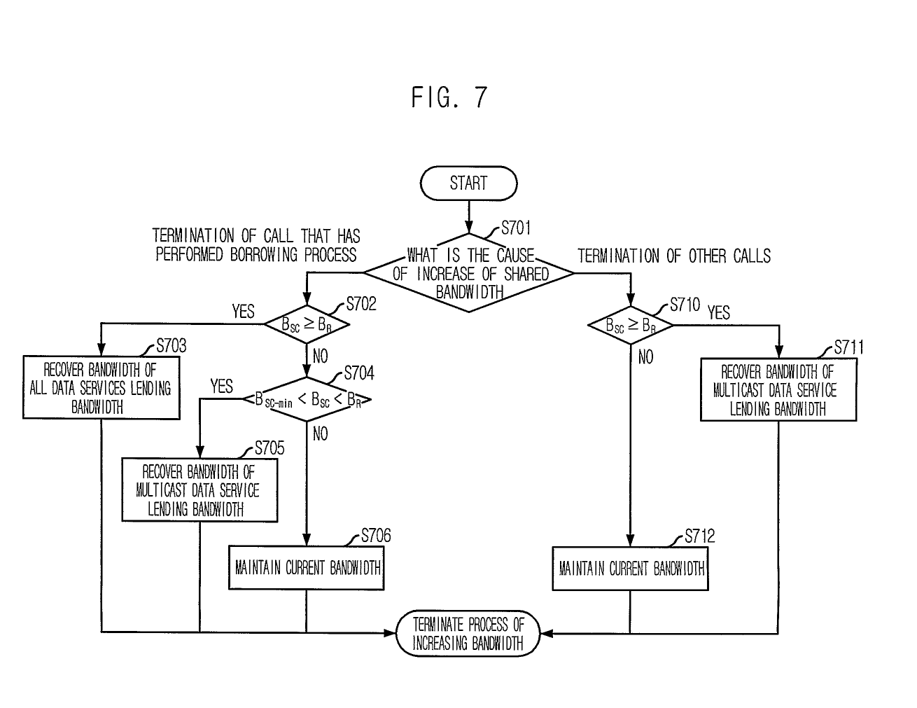

FIG. 7 is a flowchart illustrating a process of increasing bandwidth in the call admission control method in accordance with the embodiment of the present invention.

Referring to FIG. 7, in step S701, it is determined whether the shared bandwidth is increased by the termination of the call that has performed the borrowing process, or by the termination of other existing calls.

In step S702, if the shared bandwidth is increased by the termination of the call that has performed by the borrowing process, it is determined whether the bandwidth (B_{SC}) of the shared channel is equal to or greater than the bandwidth (B_{R}) considered as not greatly influencing a next call admission control even when the shared bandwidth is additionally allocated to the data service. In step S703, if B_{SC} is equal to or greater than B_{R}, the bandwidths of all data services lending the bandwidths are recovered, and the process of increasing the bandwidth is terminated. In step S704, if B_{SC} is less than B_{R}, it is determined whether B_{SC-min}<B_{SC}<B_{R} is satisfied, where B_{SC-min} represents the bandwidth that has to be maintained at least for the call admission request of other new services, B_{SC} represents the bandwidth of the shared channel, and B_{R} is the bandwidth considered as not greatly influencing a next call admission control even when the shared bandwidth is additionally allocated to the data service. In step S705, if B_{SC-min}<B_{SC}<B_{R} is satisfied in step S704, the bandwidth of the multicast data service lending the bandwidth is recovered and the process is terminated. In step S706, if B_{SC-min}<B_{SC}<B_{R} is not satisfied in step S704, the data services maintain the current bandwidths and the process is terminated.

In step S711, if the shared bandwidth is increased by the termination of other existing calls and B_{SC}≧B_{R} is satisfied, the bandwidth of the multicast data service lending the bandwidth through the borrowing process is recovered and the process is terminated. In step S712, if B_{SC}≧B_{R} is not satisfied, the current bandwidth is maintained and the process is terminated.

At this point, “B_{R} is the bandwidth that is considered as not influencing the next call admission control even when the shared bandwidth is additionally allocated to the data service, and it is determined by the service provider.” B_{SC-min} is the bandwidth that has to be maintained at least for the call admission request of other new services, and it is determined by the service provider. B_{SC-min} may be set to zero.

The system of the present invention is a system for providing the content-based broadcasting, multicast and communication services using the satellite.

The content-based broadcasting and multicast services does not transmit the broadcasting contents over a single channel, just as the existing satellite, terrestrial broadcasting or digital multimedia broadcast (DMB), but transmit the broadcasting contents every when there are the broadcasting contents to be transmitted. However, the present invention is not limited to the above-described call admission control method.

The above-described methods in accordance with the present invention can be stored in computer-readable recording media. The computer-readable recording media may include CDROM, RAM, ROM, floppy disk, hard disk, optical magnetic disk, and so on. Since these procedures can be easily carried out by those skilled in the art, a detailed description thereof will be omitted.

The present application contains subject matter related to Korean patent application No. 2005-0085904, filed in the Korean Intellectual Property Office on Sep. 14, 2005, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A call admission control method for use in a packet based communication system, comprising the steps of:
a) dividing frequency band into a reservation band and a shared band for communication service handoff call and multicast service handoff call, and determining whether a call admission request of users is a new call or a handoff call;
b) when the call admission request is the new call, determining whether to accept the call admission request by allocating the shared band and a band borrowed from other service; and
c) when the call admission request is the handoff call, determining whether to accept the call admission request by allocating the shared band, the reserved band, and the borrowed band according to services and bandwidth resources.

2. The call admission control method as recited in claim 1, wherein the step a) includes the steps of:
a1) determining whether (B_{SC}−B_{OC})>Bᵣₑ is satisfied, where B_{SC} represents the bandwidth of a shared channel, B_{OC} represents bandwidth that is being currently used in the shared channel, and Bᵣₑ represents bandwidth requested in the call admission request;
a2) when (B_{SC}−B_{OC})>Bᵣₑ is satisfied, accepting the call admission request; and
a3) when (B_{SC}−B_{OC})>Bᵣₑ is not satisfied, determining whether kind of the call is a handoff call or a new call.

3. The call admission control method as recited in claim 1, wherein when the reservation bandwidth is decided using information reported from outermost cells and
(B_{SC}−B_{OC})+B_{CHRR}−(ΣN_{C}×α)≧β,
the communication service handoff call additionally reserves bandwidth as much as
(ΣN_{C}×α)−B_{CHRR.}

4. The call admission control method as recited in claim 1, wherein when
(B_{SC}−B_{OC})+B_{CHRR}−(ΣN_{C}×α)<β,
the communication service handoff call maintains a current reservation bandwidth, where B_{SC}, B_{OC}, B_{CHRR}, and N_{C} represent the bandwidth of the shared channel, the bandwidth that is being currently used in the shared channel, the bandwidth that is not currently used in the bandwidth reserved for the communication service handoff, and the number of users, respectively, and α and β represent the handoff call reservation bands.

5. The call admission control method as recited in claim 1, wherein when the reservation bandwidth is decided, the multicast service handoff call receives multicast contents, which are being provided from outermost cells, and reserves bandwidth as much as contents that are not provided.

6. The call admission control method as recited in claim 1, wherein the step b) includes the steps of:
b1) determining whether a kind of service of the new call is a communication service, a multicast service, or a broadcasting service;
b2) when the kind of the service of the new call is the communication service, performing a process of borrowing bandwidth for a new communication service, checking that bandwidth requested by a user is allocable, and accepting the call admission request;
b3) when the kind of the service of the new call is the multicast service, accepting the call admission request; and
b4) when the kind of the service of the new call is the broadcasting service, inserting the call admission request into a call admission wait queue.

7. The call admission control method as recited in claim 1, wherein the band borrowed from the other services reduces a transmission speed of a service lending a bandwidth through a packet scheduler and increase a transmission speed of a service intended to borrow the bandwidth.

8. The call admission control method as recited in claim 1, wherein the step b3) includes the steps of:
b31) determining whether a kind of the service of the new multicast call is streaming or data;
b32) when the kind of the service of the new multicast call is the streaming, performing a process of borrowing bandwidth for the new streaming service, and checking whether bandwidth requested by the user is allocable;
b33) accepting the call admission request when the bandwidth is allocable, and inserting the call admission request into the call admission wait queue when the bandwidth is not allocable; and
b34) when the kind of the service of the new multicast call is the data, inserting the call admission request into the call admission wait queue.

9. The call admission control method as recited in claim 8, wherein the call admission request inserted into the call admission wait queue accepts the call when margin occurs in the shared bandwidth.

10. The call admission control method as recited in claim 8, wherein the process of borrowing the bandwidth is performed with respect to the handoff call, the new communication service, and the new multicast streaming service.

11. The call admission control method as recited in claim 10, wherein if
$${B}_{TRM} + {\sum }_{i = 1}^{I} ( {A}_{BD} ( i ) - {B}_{min} ) \geq {B}_{re}$$
the bandwidth is borrowed to the handoff call by reducing A_{BD}(i) with respect to all i as much as bandwidth that is not less than (Bᵣₑ/I).

12. The call admission control method as recited in claim 11, wherein if
$$\begin{matrix}{B}_{TRM} + {\sum }_{i = 1}^{I} ( {A}_{BD} ( i ) - {B}_{min} ) < {B}_{re} and \\ {B}_{TRM} + {\sum }_{i = 1}^{I} ( {A}_{BD} ( i ) - {B}_{min} ) + {\sum }_{j = 1}^{J} ( {A}_{MD} ( j ) - {B}_{min} ) \geq {B}_{re}\end{matrix}$$
the bandwidth is reduced with respect to flow of all i as much as A_{BD}(i)−Bₘᵢₙ, and the bandwidth is borrowed to the handoff call by reducing A_{MD}(j) with respect to all j as much as bandwidth that is not less than
$$\{ {B}_{re} - {B}_{TRM} - {\sum }_{i = 1}^{I} ( {A}_{BD} ( i ) - {B}_{min} ) \} / J and$$
when the two conditions are not satisfied, the bandwidth is not borrowed to the handoff call.

13. The call admission control method as recited in claim 11, wherein if
$$\begin{matrix}{B}_{RM} + {\sum }_{i = 1}^{I} ( {A}_{BD} ( i ) - {B}_{C} ) < {B}_{re} and \\ {B}_{RM} + {\sum }_{i = 1}^{I} ( {A}_{BD} ( i ) - {B}_{C} ) + {\sum }_{j = 1}^{J} ( {A}_{MD} ( j ) - {B}_{C} ) \geq {B}_{re} ,\end{matrix}$$
the bandwidth is reduced with respect to flow of all i as much as A_{BD}(i)−B_{C}, and the bandwidth is borrowed to the new communication service by reducing A_{MD}(j) with respect to all j as much as bandwidth that is not less than
$$\{ {B}_{re} - {B}_{RM} - {\sum }_{i = 1}^{I} ( {A}_{BD} ( i ) - {B}_{C} ) \} / J ; and$$
when the two conditions are not satisfied, the bandwidth is not borrowed to the new communication service call.

14. The call admission control method as recited in claim 11, wherein if
$$\begin{matrix}{B}_{RM} + {\sum }_{i = 1}^{I} ( {A}_{BD} ( i ) - {B}_{S} ) < {B}_{re} and \\ {B}_{RM} + {\sum }_{i = 1}^{I} ( {A}_{BD} ( i ) - {B}_{S} ) + {\sum }_{j = 1}^{J} ( {A}_{MD} ( j ) - {B}_{S} ) \geq {B}_{re} ,\end{matrix}$$
the bandwidth is reduced with respect to flow of all i as much as A_{BD}(i)−B_{C}, and the bandwidth is borrowed to the new multicast streaming service by reducing A_{MD}(j) with respect to all j as much as bandwidth that is not less than
$$\{ {B}_{re} - {B}_{RM} - {\sum }_{i = 1}^{I} ( {A}_{BD} ( i ) - {B}_{S} ) \} / J ; and$$
when the two conditions are not satisfied, the bandwidth is not borrowed to the new multicast streaming service call.

15. The call admission control method as recited in claim 10, wherein the process of borrowing the bandwidth determines whether to return the borrowed bandwidth to existing data services according to margin of the shared bandwidth.

16. The call admission control method as recited in claim 15, wherein the shared band is increased by termination of the call that has performed the process of borrowing the bandwidth, or by termination of existing other calls.

17. The call admission control method as recited in claim 16, wherein if the call that has performed the process of borrowing the bandwidth is terminated and B_{SC}≧B_{R} where B_{SC} represents the bandwidth of the shared channel and B_{R} represents the bandwidth considered as not greatly influencing a next call admission control even when the shared bandwidth is additionally allocated to the data service, the bandwidths of all data services lending the bandwidths are recovered.

18. The call admission control method as recited in claim 16, wherein if the call that has performed the process of borrowing the bandwidth is terminated and B_{SC-min}<B_{SC}<B_{R} where B_{SC-min} represents the bandwidth that has to be maintained at least for the call admission request of other new services, the bandwidth of the multicast data service lending the bandwidth is recovered.

19. The call admission control method as recited in claim 16, wherein if the call that has performed the process of borrowing the bandwidth is terminated, and B_{SC}≧B_{R} and B_{SC-min}<B_{SC}<B_{R} are not satisfied, all data services maintain a current bandwidth.

20. The call admission control method as recited in claim 16, wherein if the shared band is increased by the termination of the existing other calls and B_{SC}≧B_{R}, the bandwidth of the multicast data service lending the bandwidth is recovered; and if B_{SC}≧B_{R} is not satisfied, all data services maintain a current bandwidth.
